(19) United States
(12) Patent Application Publication
(10) Pub. No.: US 2015/0145304 A1
(43) Pub. Date: May 28, 2015

(54) BACKREST ADJUSTOR AND BABY CARRIAGE

(71) Applicant: O'SK Baby & Children Products (Fujian) Co., Ltd., Zhang Zhou City (CN)

(72) Inventors: Fulai YAO, Zhang Zhou City (CN); Dexiang LEI, Zhang Zhou City (CN); Jinhai HUANG, Zhang Zhou City (CN)

(21) Appl. No.: 14/555,641

(22) Filed: Nov. 27, 2014

(30) Foreign Application Priority Data
Nov. 28, 2013 (CN) 201320772970.4

(51) Int. Cl. B62B 9/10

(52) U.S. Cl. CPC B62B 9/104
USPC 297/354.12

(57) ABSTRACT

A backrest adjustor comprises a shell, a rotary gear located inside the shell, a winding wheel which is driven by the gear and located inside the shell, a knob for driving the gear to rotate, and a button capable of controlling the gear to rotate, moving and being reset by a reset component. A rotating portion of the knob is exposed outside the shell. The backrest adjustor further comprises a ribbon, the middle segment of which is wound on the winding wheel while two ends of which used for connecting a frame of a baby carriage extend from the shell and are then wound around the outer face of the backrest.

### FIELD OF THE INVENTION

The present invention relates to a backrest adjustor, a backrest adjustor for a baby carriage, and further to a baby carriage, belonging to the technical field of baby carriages.

### BACKGROUND OF THE INVENTION

In the prior art, a backrest for a conventional baby carriage is provided with a ribbon having an adjustable buckle provided thereon. The backrest is allowed to ascend or descend by adjusting the length of the ribbon via the adjustable buckle, and the position of the backrest may be adjusted by the ribbon and the adjustable buckle. However, such an adjustment device requires both hands during the whole adjustment, and is time-consuming and quite inconvenient in operation especially for users carrying with children because they have to do this while taking care of children.

### SUMMARY OF THE INVENTION

The technical problem to be solved in the present invention is to provide a backrest adjustor which is simple in structure and convenient and easy in adjustment.

The present invention further relates to a baby carriage.

The present invention may employ the following technical solutions.

A backrest adjustor is provided, including a shell, a rotary gear located inside the shell, a winding wheel which is driven by the gear and located inside the shell, a knob for driving the gear to rotate, and a button capable of controlling the gear to rotate, moving and being reset by a reset component, a rotating portion of the knob being exposed outside the shell; the backrest adjustor further includes a ribbon, the middle segment of which is wound on the winding wheel while two ends of which used for connecting a frame of a baby carriage extend from the shell and are then wound around the outer face of a backrest; or, the backrest adjustor further includes two ribbons, one ends of which are separately wound on the winding wheel while the other ends of which used for connecting frame of the baby carriage extend from the shell separately and are then wound around the outer face of the backrest.

To solve the problem, the present invention may further employ the following improvement measures.

The winding wheel, the gear and the knob are coaxial and formed integrally.

The winding wheel is located on the inner side of the gear.

The winding wheel is located between the gear and the knob.

The reset component is a torsion spring which is in contact with the button, a portion of the button can extend into a tooth slot, and the button is provided with a member to be pressed which is exposed outside the shell.

The button is mounted on a rotating column disposed inside the shell.

The shell includes an upper cover and a lower cover, which are connected to each other to form the shell.

The position relationship between the gear and the button contributes to a ratchet structure.

The technical solution of the baby carriage is as follows:

A baby carriage is provided, including a frame having a backrest provided thereon, and further including the backrest adjustor described above, the backrest adjustor being located on an outer side of the backrest, corresponding ends of a ribbon in the backrest adjustor being connected to the frame.

The above technical solutions have the following technical effects:

1. The backrest adjustor provided by the present invention is simple in structure, convenient and easy in adjustment and capable of allowing adjustment by a single hand, and the backrest adjustor is suitable for users carrying with children.

2. With the backrest adjustor, the baby carriage provided by the present invention is simple in structure, convenient and easy in adjustment and capable of allowing adjustment by a single hand, and the baby carriage is suitable for users carrying with children. As the other portion of the ribbon is hidden inside the adjustor, the adjustor has a nice appearance.

### BRIEF DESCRIPTION OF THE DRAWINGS

FIG. 1 is a front view of the present invention;

FIG. 2 is an internal structure diagram of the present invention;

FIG. 3 is an exploded view of the present invention; and

FIG. 4 is a schematic diagram of a baby carriage according to the present invention.

### DETAILED DESCRIPTION OF THE PREFERRED EMBODIMENTS

The present invention will be specifically described with reference to specific embodiments.

### Embodiment 1

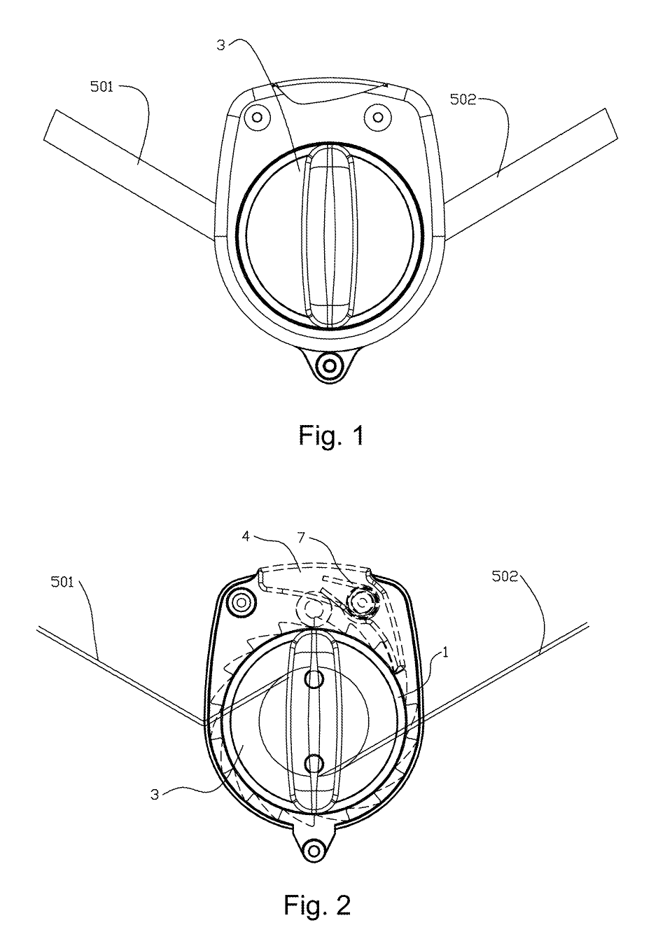

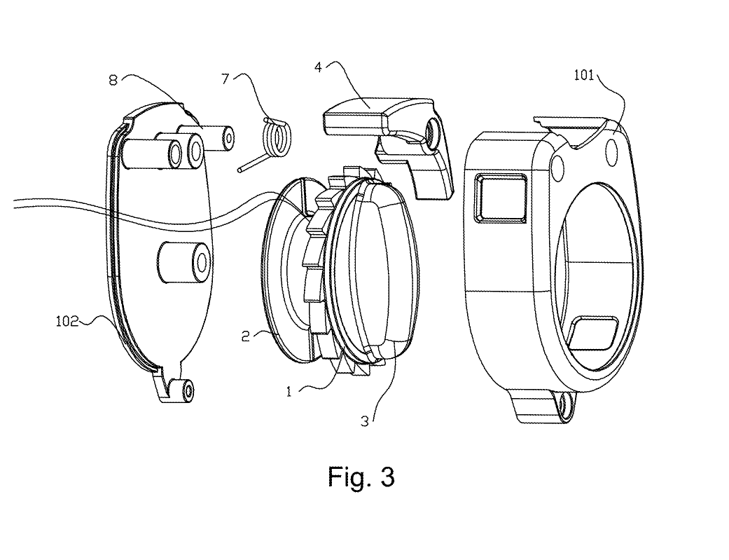

As shown in FIG. 1 to FIG. 4, a backrest adjustor is provided, including a shell, a rotary gear 1 located inside the shell, a winding wheel 2 which is driven by the gear 1 and located inside the shell, a knob 3 for driving the gear 1 to rotate, and a button 4 capable of controlling the gear 1 to rotate, moving and being reset by a reset component. A rotating portion of the knob 3 is exposed outside the shell. The shell includes an upper cover 101 and a lower cover 102, which are connected to each other to form the shell. Of course, the shell may be formed from multiple connected portions.

The backrest adjustor further includes two ribbons 501 and 502. One ends of the two ribbons are separately wound on the winding wheel while the other ends thereof used for connecting a frame 6 of a baby carriage extend from the shell and are then wound around the outer face of a backrest 5.

The winding wheel 2, the gear 1 and the knob 3 are coaxial and formed integrally, so that the backrest adjustor is compact in structure and space-saving. The winding wheel 2 is located on the inner side of the gear 1.

The reset component is a torsion spring 7 which is in contact with the button 4. A portion of the button 4 may extend into a tooth slot of the gear 1. The button 4 is provided with a member to be pressed which is exposed outside the shell. The button 4 is mounted on a rotating column 8 disposed inside the shell. Of course, the button 4 may be mounted by other conventional methods.

The position relationship between the gear and the button contributes to a ratchet structure.

The working principle will be described as below. First, the gear 1 is rotated and the ribbons are wound on the winding wheel, so that the ascending of the backrest is realized by adjusting the length of the ribbons. The button is blocked on the gear under the action of the torsion spring, so that the reverse rotation of the gear is avoided. Therefore, the backrest adjustor is simple in structure and convenient and easy in adjustment, and may be adjusted by a single hand. Second, release operation: the button is pressed down by a hand and then the button is disengaged from the gear, so that the gear may rotate reversely and the ribbons may be pulled out, realizing the lying of the backrest 5.

As another embodiment, the characteristic lies in that: in this embodiment, one ribbon is utilized, the middle segment of which is wound on the winding wheel while two ends of which used for connecting a frame of a baby carriage extend from the shell and are then wound around the outer face of a backrest.

As another embodiment, the characteristic lies in that: the winding wheel is located between the gear and the knob. A simple structure is realized.

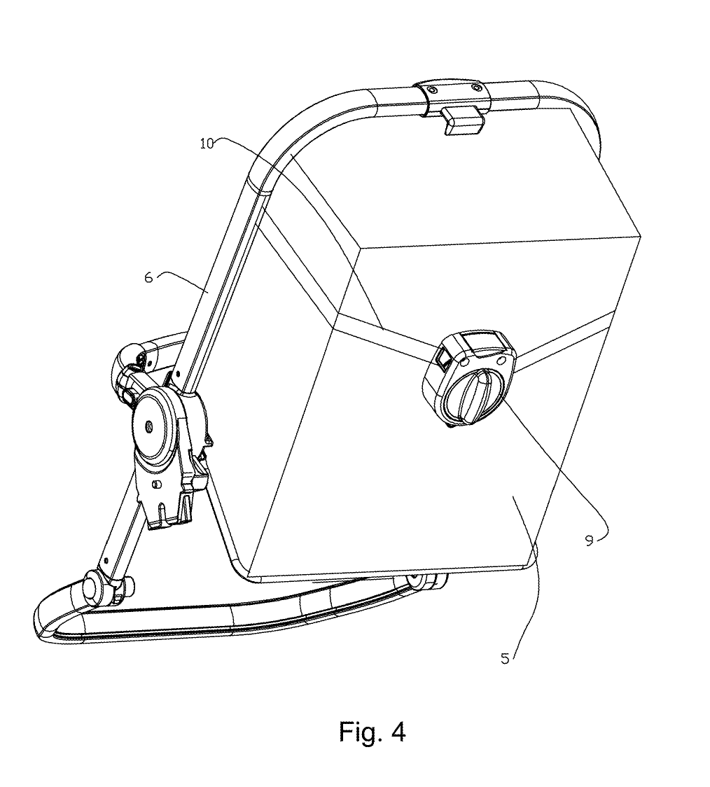

As another embodiment, as shown in FIG. 4, a baby carriage is provided, including a frame 6 having a backrest 5 provided thereon, and further including the backrest adjustor described above. The backrest adjustor is located on the outer side of the backrest, and a ribbon 10 of the backrest adjustor is connected to frame.

The forgoing description merely shows the specific embodiments of the present invention, and the protection scope of the present invention is not limited thereto. Any variation or displacement readily thought by those of ordinary skill in the art upon the disclosure of the present invention shall fall into the protection scope of the present invention. Therefore, the protection scope of the present invention shall be subject to the appended claims.

What is claimed is:

1. A backrest adjustor, comprising a shell, a rotary gear located inside the shell, a winding wheel which is driven by the gear and located inside the shell, a knob for driving the gear to rotate, and a button capable of controlling the gear to rotate, moving and being reset by a reset component, a rotating portion of the knob being exposed outside the shell; the backrest adjustor further comprising a ribbon, the middle segment of the ribbon being wound on the winding wheel, two ends of the ribbon used for connecting a frame of a baby carriage extending from the shell and being then wound around the outer face of a backrest; or, the backrest adjustor further comprising two ribbons, one ends of which being separately wound on the winding wheel and the other ends of which used for connecting frame of the baby carriage extending from the shell separately and being then wound around the outer face of the backrest.

2. The backrest adjustor according to claim 1, wherein the winding wheel, the gear and the knob are coaxial and formed integrally.

3. The backrest adjustor according to claim 2, wherein the winding wheel is located on the inner side of the gear.

4. The backrest adjustor according to claim 2, wherein the winding wheel is located between the gear and the knob.

5. The backrest adjustor according to claim 1, wherein the reset component is a torsion spring which is in contact with the button, a portion of the button can extend into a tooth slot of the gear, and the button is provided with a member to be pressed which is exposed outside the shell.

6. The backrest adjustor according to claim 5, wherein the button is mounted on a rotating column disposed inside the shell.

7. The back adjustor according to claim 1, wherein the shell comprises an upper cover and a lower cover, which are connected to each other to form the shell.

8. The back adjustor according to claim 1, wherein the position relationship between the gear and the button contributes to a ratchet structure.

9. A baby carriage, comprising a frame having a backrest provided thereon, and further comprising the backrest adjustor according to claim 1, the backrest adjustor being located on an outer side of the backrest, corresponding ends of a ribbon in the backrest adjustor being connected to the frame.

10. A baby carriage, comprising a frame having a backrest provided thereon, and further comprising the backrest adjustor according to claim 2, the backrest adjustor being located on an outer side of the backrest, corresponding ends of a ribbon in the backrest adjustor being connected to the frame.

11. A baby carriage, comprising a frame having a backrest provided thereon, and further comprising the backrest adjustor according to claim 3, the backrest adjustor being located on an outer side of the backrest, corresponding ends of a ribbon in the backrest adjustor being connected to the frame.

12. A baby carriage, comprising a frame having a backrest provided thereon, and further comprising the backrest adjustor according to claim 4, the backrest adjustor being located on an outer side of the backrest, corresponding ends of a ribbon in the backrest adjustor being connected to the frame.

13. A baby carriage, comprising a frame having a backrest provided thereon, and further comprising the backrest adjustor according to claim 5, the backrest adjustor being located on an outer side of the backrest, corresponding ends of a ribbon in the backrest adjustor being connected to the frame.

14. A baby carriage, comprising a frame having a backrest provided thereon, and further comprising the backrest adjustor according to claim 6, the backrest adjustor being located on an outer side of the backrest, corresponding ends of a ribbon in the backrest adjustor being connected to the frame.

15. A baby carriage, comprising a frame having a backrest provided thereon, and further comprising the backrest adjustor according to claim 7, the backrest adjustor being located on an outer side of the backrest, corresponding ends of a ribbon in the backrest adjustor being connected to the frame.
